(19) United States
(12) Patent Application Publication
(10) Pub. No.: US 2012/0190344 A1
(43) Pub. Date: Jul. 26, 2012

(54) APPARATUS FOR RECEIVING VOICE MESSAGE OF THE TEXT PAGER

(75) Inventor: SHIH-TSENG YEH, New Taipei City (TW)

(73) Assignee: Unication Group/Unication Co., LTD., New Taipei City (TW)

(21) Appl. No.: 13/354,325

(22) Filed: Jan. 19, 2012

(30) Foreign Application Priority Data
Jan. 20, 2011 (TW) 100201397

(51) Int. Cl. H04W 4/12; H04M 11/10

(52) U.S. Cl. 455/413

(57) ABSTRACT

An apparatus for receiving voice message of the text pager, the pager are used to receive text messages from sender, particularly to the pager was installed an audio processing modules and for listen to the voice message over the target channel. The pager will burn into a plurality of private channels that to forming a channels list inside thereof, provide for user can obtain an target channel from the channels list which use method of manually select or channel scan, which to listen to the analog/digital voice message associated with the dispatch events.

### BACKGROUND OF THE INVENTION

1. Field of the Invention

The present invention generally relates to a paging communication system and, more particularly, to an apparatus of the pager for receiving a text messages from sender via radio paging channel, and further comprises at least one audio processing modules and a channels list is establishing within the pager, so as to executed manually or automatically select a target channel to listen the analog/digital voice message on the target channels.

2. The Related Art

According to, traditional text pagers have low energy consumption, low cost, small size, and be easy to carry about of features, commonly used for dispatch notifications of a variety of emergency teams (such as police, fire, medical, rescue and military, and the like). For example, the traditional text pager received the emergency notification of text message from the central console when the member (user) only carried the text pager, which received text message that is only brief description to the event properties and locations such as the basic information, thus unable to get a Further detailed information associated with the emergency events from the text message (such as event risk rating, size, scope and other details of the actual situation), desires to understand the events and severity thereof that lead to the members of the participate in assign task must arrived at the scene. In such situations, the members participating in the task can not to effectively and immediately carry the task due to lack of the necessary tools and equipment, lead to delays in emergency rescue work and waste of human resources.

Another traditional text pager, when received emergency notification of text messaging from sender (central console), the members may be in response to received notification message then transmitting acknowledgement signal to sender via the GSM systems, which causes that sender can only be know to the members received emergency notification and he/she is going to the place venue of the event. However, still unable to further understand details about the event when received emergency notification for the members, or can't receiving voice information from radio channel of the other rescue groups. In such situations, similarly was not conducive to the implementation the emergency tasks of disadvantages.

Accordingly, there is a need for improved the text pagers, which allows traditional text pager can also be receiving a voice message capabilities.

### SUMMARY OF THE INVENTION

The present invention relate to a text pager device for capable of receiving a voice message from the sender are disclosed, the pager comprise at least: a radio receiver for receiving a text messages from the sender (such as console); a processor coupled to a radio receiver, a display, and an input unit that for convert and transfer the received text message to display the text content on the display and for reception a command from the input unit to operates the pager; the processor further coupled to an audio processing modules, that audio processing modules comprises at least one antenna, audio decoder, an audio amplifier and a speaker. Wherein the audio processing modules for monitoring (or listen) to an analog/digital voice message on the target channel, that target channel is provided by the processor.

As mentioned above, wherein the processor further comprises burn into (write into) a plurality of private channels to forming a channels list, that will a target channel selected from the channels list provided for user to listen the voice message associated with events.

Wherein the processor further comprises a scan channels program to scanning each channel on the channels list and will demodulating and decoding the scanned RF signal convert into a sound broadcast through the speaker, thus provide for user may monitor to the analog/digital voice messages on the selected channel.

Wherein the selected target channels comprises executed manual operation of the input unit on the pager by user, which to get the target channel quickly selected from the channels list.

Wherein the selected target channels comprises execute automatic scan channels program through processor of the pager which to scanning each channels according to priority in the channels list, and monitor the received a voice message (broadcast) content on the channel to obtain the target channel.

According to, the present invention of the text pager that in addition to reception traditional text messages, also to reception voice message associated with an event transmitted from a central console, a two-way radios or other RF communication device, aims to enhance the efficacy of the pager.

### BRIEF DESCRIPTION OF THE DRAWINGS

The invention will be described in greater detail below with reference to favorable embodiments introduced by way of example and with reference to the attached drawings, where:

FIG. 1 is an implemented a block diagram of the circuit with the present invention.

FIG. 2 is an implemented a configuration diagrams with the present invention.

FIG. 3 is other implementation a block diagram of the circuit with the present invention.

### DETAILED DESCRIPTION OF THE PREFERRED EMBODIMENT

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

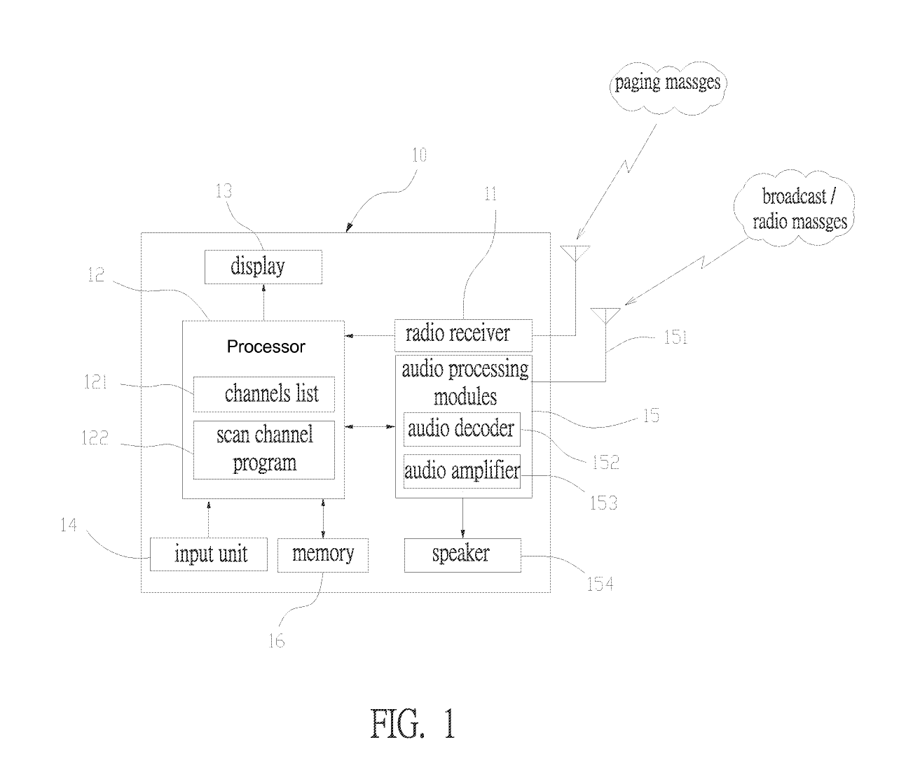

With reference to FIG. 1, an apparatus for receiving voice message of the text pager, the pager 10 comprises at least: a radio receiver 11 for receiving text messages from the sender (Dispatch console) 20; a processor 12 coupled to a radio receiver 11, a display 13, and an input unit 14 that for convert and transfer the receiving text message from radio receiver 11 to display the text content on the display 13 and for reception a command from an input unit 14 to processor 12 executing program; and the processor 12 also coupled to an audio processing module 15, the audio processing module 15 comprises at least an antenna 151, an audio decoder 152, an audio amplifier 153, and a speaker 154, wherein the audio processing modules 15 have a frequency of the selected target channel provided by the processor 12 and listen to the analog/digital voice message over the target channel.

In the pager 10, wherein the processor 12 further connection to a memory 16 for saving (store) the a plurality of special channel (e.g., police, fire fighters, medical, rescue, military personnel, or other similar public channels, etc.) to compile an channels list 121, thus provided for user can be select a target channel fast from the channels list 121 and to listen to the voice message over the target channel. As above the processor 12 and the memory 16 that can made into two separate crystal form and can also be made into a single crystal form.

The processor 12 further burn (write)) into a scan channel program 122, the scan channel program 122 can be executed manually by the input unit 14, or automatically start based on the program to operation started, for implement channel scan function according to priority in the channels list 121, thus order scanning a plurality of channel in the channels list 121, and determine of an identify channel depends on voltage of the received signal strength indicator (RSSI) in middle frequency IC system, and will decoding of sound by the audio decoder 152 to display through the speaker 154, that provides user can monitor (or listen to) the voice messages transmitted over the channel at in the process of scan.

Wherein the selected target channels comprises to getting a target channel selected quickly from the channels list 121 of display on the display 13, which to manual operation by the user at input unit 14 on the pager 10.

Wherein the selected target channels comprises to getting a target channel automatic selected from according to priority in the channels list 121, which the scan channels program execute through the processor 12 of the pager 10 to scanning each channel, and monitoring the voice message (broadcast) received from various channels.

As said personal pager 10, can also be combined an antenna 151 coupled to audio processing modules 15 with an antenna coupled to radio receiver 11 together into a sole antenna of receiver module.

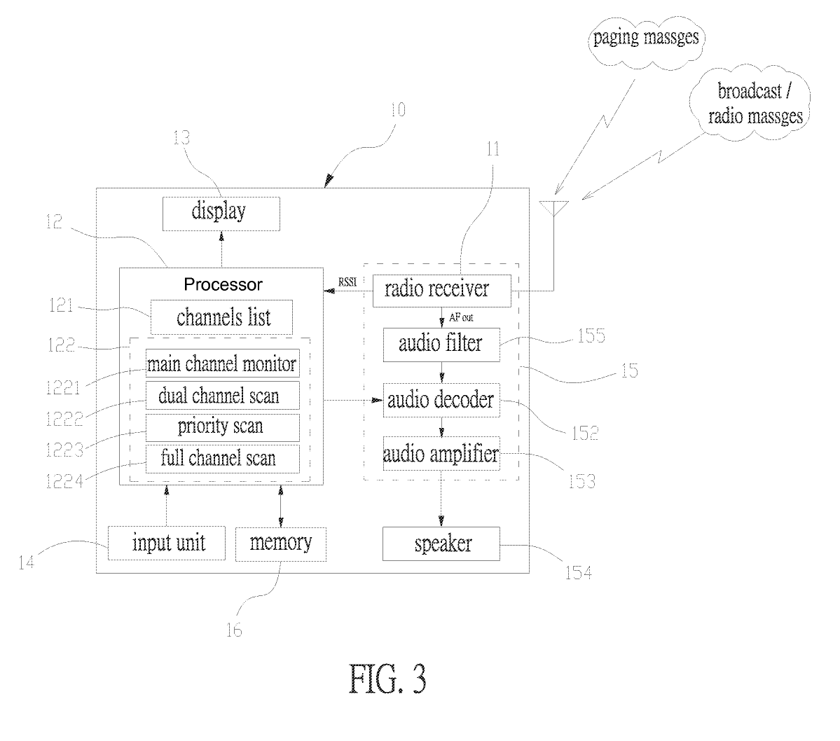

Referring to FIG. 3, Wherein the radio receiver 11 coupled to the processor 12, and also coupled to an audio filter 155, audio decoder 152, audio speakers 153, and amplifier 154, thus realizing the functions of a can be receive text information and radio audio information.

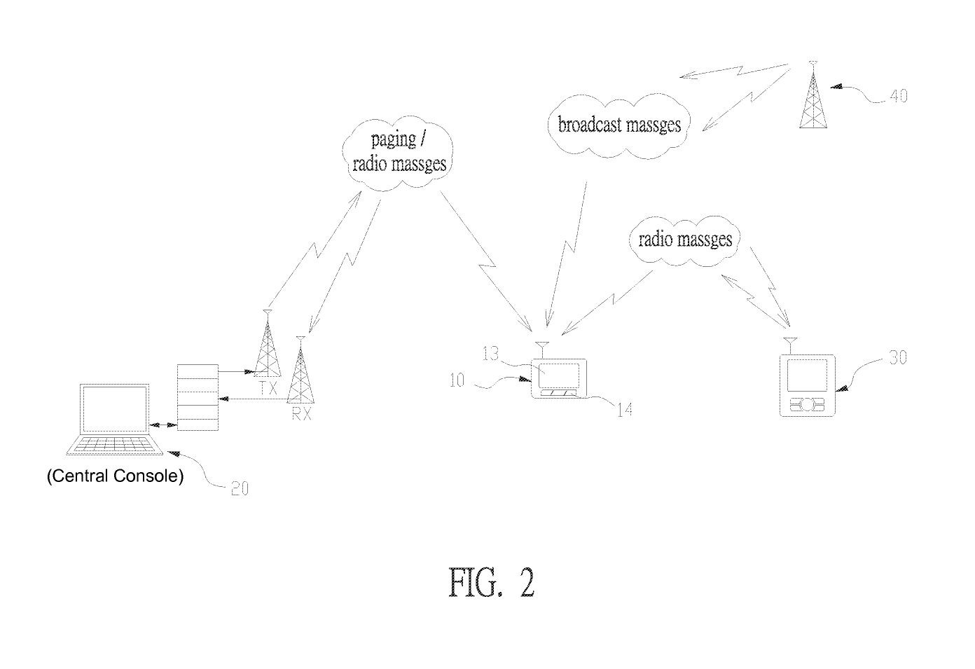

Referring also to FIG. 2, when the pager 10 device is implemented, for example, the pager 10 for the dispatching jobs of emergency dispatch, when received a dispatch text message associated with that emergency event sent by the sender 20 (such as the central console or other radio equipment), the received dispatch text message of the user (member) may then be reoperation to pager 10, that can be executed manually or automatically to listen to the analog/digital voice message associated with dispatch events, or other message or latest of site reports; Also the audio processing modules 15 comprises at least one of the modulation/demodulation and decoders for processing the analog radio signals (such as CTCSS and the CDCSS, 2 tone, and 5/6 Tone, and MDC/200, UDC2400) or digital radio signals (such as DMR, P25, Tetra).

The above embodiment, when the members at enabled audio processing module 15 during, can be selects a target channel associated with dispatch events from the channels list 121 of display on the display 13, which executed manually operation the input unit 14 on the pager 10, and will receive signals on the target channel decoding through audio decoder 152 produced sound broadcast through the speaker 154, thus provide for user to monitor (or listen) the analog/digital voice messages on the channel; Wherein the target channels can be broadcast channel of the central console of same group or voice channel of the other radio groups (such as using two-way radio 30 or other public radio station 40 of teammate or other rescue group in the event field).

In addition, when the members at enabled audio processing module 15 during can also be selection a target channel associated with dispatch events from scanning each channel based on priority of the channels list 121, which executed manually or automatically command that to the processor 12 perform function of scan channel program 122, and to monitoring the received voice message on the scan channels and determining the contents of message whether associated with the event in the process of scan, then operating the at least one of “ maintain ” or “ Skip ” key on the input unit 14 is designated, which to listen the voice messages remained in the channel, or quickly skim the channel so that scanning next channel until found the desires channel, thus accomplished the function of the to listen voice message associated with dispatch events.

As scan channel program 122 above, for gets a desired to target channel which can also be executed automatically scan present of specifies channels or all channel in the air, so that can also be operating to either “ maintain ” or “ Skip ” function key to monitor and listen to the analog/digital voice message when that not have or not preparatory channel in the channels list 121.

And, as scan channel program 122 above, that further as arranged at least to be returned to scan once main channel once every one or/and two or other scanned order after scanning other channel in the channels list 121 for prevent a leakage emergency message of the main channel in the pager system when the scanning special channels are long time during.

Referring also to FIG. 3, wherein the scan channel program 122 for automatic control with the reduced unnecessary to scan channel operation, therefore the scan channel program 122 may further comprises at least one of a main channel monitor 1221, a dual channel scan 1222, a priority scan 1223, and full channel scan 1224 of the subprogram, used for control the amount and order of automatic scan channels in the air. Also, wherein can directly adjustments sound or/and RSSI signal of intensity when the any function of the subroutine is started facilitate voice message of reception and broadcast.

As mentioned above, in the main channel monitor 1221, will be priority scan main channel of originally specified in the pager 10, if that received voice message of same frequency matched for receiving frequency of the main channel, such as received voice messages associated with the emergency event of transmitted through the emergency broadcast system or 2-way radio then will be broadcast the received voice messages.

In the double channel scan 1222, will be an originally main channel and a second channel (the other channels of specifies by the user) display in scanning channels list 121 of the pager 10 and will be priority scan main channel. If that received RSSI signal of conditions on the main channel are contented, the pagers 10 will be to listen the voice messages associated with the emergency or events remained in the channel then will broadcast the received voice messages; If that may not received any RSSI signal of conditions on the main channel within the scheduled time are contented, will automatically jump to scan second channel and if received RSSI signal of conditions on the second channel are contented, will to listen the voice messages associated with the emergency or events remained in the channel then will be broadcast the received voice messages. In the status, will be automatically scan main channel once every at interval of a priority sample time returned from the second channel, and determining scan main channel whether have received RSSI signal of conditions are contented, if yes thus gave up second channel and remain in main channel; if no will be jump back to second channel continues receive signal, and can be pressing “ maintain ” key by the user for will second channel written into self programming when received voice messages on the second channel, and capable to listen messages remained in the second channel.

In the priority scan 1223, will be an originally main channel, a second channel, and at least a non-priority channel display in scanning channels list 121 of the pager 10 and will be priority scan main channel. If that received RSSI signal of conditions on the main channel are contented, the pagers 10 will be to listen the voice messages remain in main channel and broadcast the received messages until not received RSSI signal of conditions within the scheduled time are contented in the main channel will be automatically jump to second channel to scanning; and if that received RSSI signal of conditions on the second channel are contented, also will to listen and broadcast the received voice messages remain in second channel until end of the remained conditions then automatically jump to at least one non-priority channel to scanning, and so on.

As above embodiment, that will not leave automatically when remained in main channel but the will be automatically scan main channel once every at interval of priority sample time when remained in the second channel; which if the main channel have signal will remain on this, if absence will automatically jump back second channel to scanning when interval of a priority sample time expires; And when have received to voice messages in the second channel or one non-priority channels, and can also be pressing the “ maintain ” key for written into self programming then to listen the voice messages remained in the second channel or non-priority channel.

In the full channel scan 1224, that will be according to priority scan all channel of the channels list 121 in pager 10, use the same method above, priority scan main channel then one by one scan to last a channel, if have a voice messages from any one channel in the scan during, the pager 10 will be remain on this channel and broadcast all received voice messages, until within scheduled time does not meet the conditions of RSSI signal or executed manually disconnect by user, then jump to the next channel to scanning Then in accordance with the same rules continues to scan next channel until the last one channel does not meet conditions of remain, then jump back to main channel scanning, and so on, and, when a voice message is received in any channel, user can pressing the “maintain” key for written into self program.

What is claimed is:

1. An apparatus for receiving voice message of a text pager, wherein the pager comprises at least:
a radio receiver for receiving text messages from the sender;
a processor coupled to a radio receiver, a display, and an input unit that for convert and transfer the received text message to display the text content on the display and for accept a command from input unit to operates the pager, and the processor further comprises burn into at least one private channel or/and at least one plurality of private channels to forming a channels list; and
an audio processing modules coupled to the processor, the audio processing modules comprises at least one antenna, an audio decoder, an audio amplifier, and a speaker, the audio processing modules for listen to voice messages form a selected target channel providing by processor.

2. The apparatus according to claim 1, wherein the processor further comprises burn into a scan channels program, for enables to scan each channel according to priority in the channels list.

3. The apparatus according to claim 1, wherein the selected target channel comprises to getting a selected target channel from the channels list which to execute manual operation input unit on the pager by the user.

4. The apparatus according to claim 1, wherein the selected target channels comprises to getting a selected target channel from the channels list which to execute automatic scan channels program through the processor of the pager.

5. The apparatus according to claim 1, wherein the audio processing modules comprises processing at least one of analog radio signals or digital radio signals.

6. The apparatus according to claim 1, wherein the audio processing modules with the radio receiver are together connect to sole antenna.

7. The apparatus according to claim 1, wherein the scan channel program further comprises at least to be returned to scan once main channel once every one or/and two scan other channel after in the channels list.

8. The apparatus according to claim 1, wherein the scan channel programs comprises at least one of a main channel monitor, a dual channel scan, a priority scan, and full channel scan of the subprogram, used for control of amount and order of automatic scan channels in the air.
